(19) United States
(12) Patent Application Publication
(10) Pub. No.: US 2017/0051712 A1
(43) Pub. Date: Feb. 23, 2017

(54) Fuel Injector Filter

(71) Applicant: Delphi International Operations Luxembourg S.A.R.L., Bascharage (LU)

(72) Inventors: Ludovic Sauvetre, Cellettes (FR); Antonin Cheron, Fleury Les Aubrais (FR)

(21) Appl. No.: 15/308,196

(22) PCT Filed: Apr. 14, 2015
(86) PCT No.: PCT/EP2015/058022

§ 371 Date: Nov. 1, 2016

(30) Foreign Application Priority Data
May 1, 2014 (EP) 14166770.9

(51) Int. Cl. F02M 47/02; F02M 61/10; F02M 61/16

(52) U.S. Cl. CPC F02M 47/027; F02M 61/165; F02M 61/10; F02M 2200/27

(57) ABSTRACT

A fuel injector an internal combustion engine includes a filter for filtering fuel flowing into the control valve, the filter includes multiple filter orifices, provided on a sleeve surrounding the control valve, or on a filter element integral to the sleeve, or a filter element or plate located between an entry to the INO (inlet orifice) from a main fuel supply passage and the control valve, thereby filtering fuel contaminant particles from the flow of fuel entering the control valve, thereby reducing or eliminating control valve seat wear and subsequent leakage.

### CROSS REFERENCE TO RELATED APPLICATIONS

This application is a national stage application under 35 USC 371 of PCT Application No. PCT/EP2015/058022 having an international filing date of Apr. 14, 2015, which is designated in the United States and which claimed the benefit of EP Patent Application No. 14166770.9 filed on May 1, 2014 the entire disclosures of each are hereby incorporated by reference in their entirety.

### TECHNICAL FIELD

The present invention relates to fuel injector for delivering fuel such as diesel to a combustion space of an internal combustion engine, and more particularly to a filter for a control flow of a fuel injector.

### BACKGROUND OF THE INVENTION

The present invention relates to a fuel injector used in the delivery of fuel to a cylinder of an internal combustion engine of the type in which fuel such as diesel is supplied from a high pressure accumulator, e.g. a common rail, to fuel injectors.

Such fuel injectors generally comprise a needle which is slidable within a body and engageable with a needle valve seat to control the flow of fuel from a high pressure fuel supply line through the injector body.

The injector is indirectly controlled by means of a control valve arrangement which controls the pressurising or discharging of a nozzle control chamber located above the injector needle. When the control valve arrangement is closed, the valve member is in contact with a valve seat under the action of a spring. Upon actuation of an actuator such as a solenoid, the spring force is overcome and the control valve opens by movement of the valve member away from the valve seat, thereby opening a flow path between the nozzle control chamber and a low pressure drain. As the pressure reduces within the nozzle control chamber, the needle leaves a needle valve seat due to pressure acting against a portion of the needle adjacent the valve seat.

When the control valve is closed, the valve seat must be perfectly sealed for the correct operation of the injector. In prior art embodiments, static leakage at the control valve seat is a known problem. Leakage of the valve seat leads to a reduction in efficiency, or possible failure of the injector. Static leaks are significant since the control valve is closed more often than it is open, and are particularly relevant in view of the continuing trend towards higher operating pressures (for example 2200 to 3000 bar) for fuel injected into the combustion chamber.

Leakage at the control valve seat can be caused by hard contaminant particles in the flow of fuel flowing through the control valve causing damage to the valve seat.

Furthermore, leakage can occur due to distortion of the control valve body and/or the control valve member, caused by radial loading applied to the control valve body/control valve member.

### SUMMARY OF THE INVENTION

It is an object of the present invention to at least mitigate some of the problems associated with prior art fuel injectors and control valves.

Accordingly the present invention provides, in a first aspect, a fuel injector for use in delivering fuel in an internal combustion engine, the fuel injector comprising a nozzle, a control valve body, a fuel supply line, and a needle moveable to control ejection of fuel through at least one nozzle hole, the fuel supply line supplying fuel to the nozzle control chamber via an inlet orifice and to the nozzle; the needle being controlled by variation of pressure of fuel within in a nozzle control chamber; the pressure of fuel within the nozzle control chamber being controlled by a control valve in the control valve body, the control valve being movable between an open position wherein a fuel path is provided between the nozzle control chamber and a low pressure fuel return line, via a spill orifice and the control valve, and a closed position wherein the control valve closes the flow path; wherein a filter is provided at a position between an entry to the inlet orifice from the fuel supply line, and the control valve, such that fuel passes through the filter before entering the control valve.

The present invention provides filtration of the flow entering the control valve, thereby preventing hard contaminant particles likely to cause wear to the control valve seat from passing through the control valve seat, thereby reducing the risk of leakage, reduction in performance, or failure of the injector.

The filter orifices may be provided on a sleeve surrounding the control valve, and may comprise slots or micro-drilled holes, the of which may be coincident or non-coincident with a radial axis of the sleeve.

The filter orifices may be arranged symmetrically around the sleeve.

The sleeve may comprise an annular filter element on which the filter orifices are provided, wherein the filter element is attached to at least one further sleeve element.

The filter may be located between an entry to the inlet orifice from the fuel supply line, and the spill orifice channel.

In an alternative embodiment the filter may be provided by a filter element comprising a plurality of filter orifices, which may be located between the nozzle control chamber and the spill orifice channel, or between the entry to the inlet orifice from the fuel supply line, and the nozzle control chamber.

The filter element may comprise a filter plate comprising a plurality of filter orifices. The filter plate may be integral with an electrically insulating separating plate which separates the control valve body and a further section of the injector containing the nozzle control chamber.

The filter plate is located between the nozzle control chamber and the spill orifice channel, or between the entry to the inlet orifice from the fuel supply line, and the nozzle control chamber.

The fuel injector may further comprise a nozzle path orifice through which fuel from the fuel supply line flows into the nozzle control chamber, wherein the nozzle path orifice is formed by a filter plate.

In a further alternative embodiment, the filter may be provided by a plurality of micro-drilled channels located between the nozzle control chamber and the spill orifice channel.

The filter may forms a spill orifice or the inlet orifice.

In a further alternative embodiment, the filter may be provided by a filter tube located in the spill orifice channel.

### BRIEF DESCRIPTION OF THE FIGURES

FIGS. 1 to 4 are cross-sectional views of an injector in accordance with the prior art;

FIG. 5 is a cross-sectional view of an injector in accordance with a first embodiment of the present invention;

FIG. 6 is a cross-sectional view of the control valve arrangement of the injector of FIG. 5;

FIG. 7 is a partially cross-sectional view of the control valve arrangement of the injector FIG. 5;

FIG. 8 is an isometric partial view of the control valve arrangement of the injector of FIG. 5 with the annular chamber and SPO channel shown as transparent;

FIG. 9 is a partially cross-section view of a control valve arrangement in accordance with a second embodiment of the first group of the present invention;

FIG. 10 is a detailed partial view of the control valve arrangement of FIG. 8 with the annular chamber and SPO channel shown as transparent;

FIG. 11 is a partially cross-sectional view of a control valve arrangement in accordance with a third embodiment of the first group of the present invention;

FIG. 12 is cross-sectional view of the control valve arrangement of FIG. 11;

FIG. 13 is an isometric partial view of the control valve arrangement of FIG. 11 with the annular chamber and SPO shown as transparent;

FIG. 14 is a cross-sectional view of a control valve arrangement in accordance with a first embodiment of a second group of the present invention;

FIG. 15 is an isometric partial view of the filter element of the control valve arrangement of FIG. 14 with surrounding injector components shown in cross-section;

FIG. 16 is a cross-sectional view of a control valve arrangement in accordance with a second embodiment of a second group of the present invention;

FIG. 17 is a detailed isometric view of the filter element of the control valve arrangement of FIG. 16 with surrounding injector components shown in cross-section;

FIG. 18 is a detailed view of an alternative control valve assembly in accordance the second embodiment of the second group of the present invention including two filter elements, with surrounding injector components shown as transparent;

FIG. 19 is a cross-sectional view of a control valve arrangement in accordance with a third embodiment of the second group of the present invention;

FIG. 20 is a cross-section view of a control valve arrangement in accordance with a fourth embodiment of the second group of the present invention;

and

FIG. 21 is an isometric partial view of the injector of FIG. 20 with components shown as transparent.

### DESCRIPTION OF THE PREFERRED EMBODIMENTS

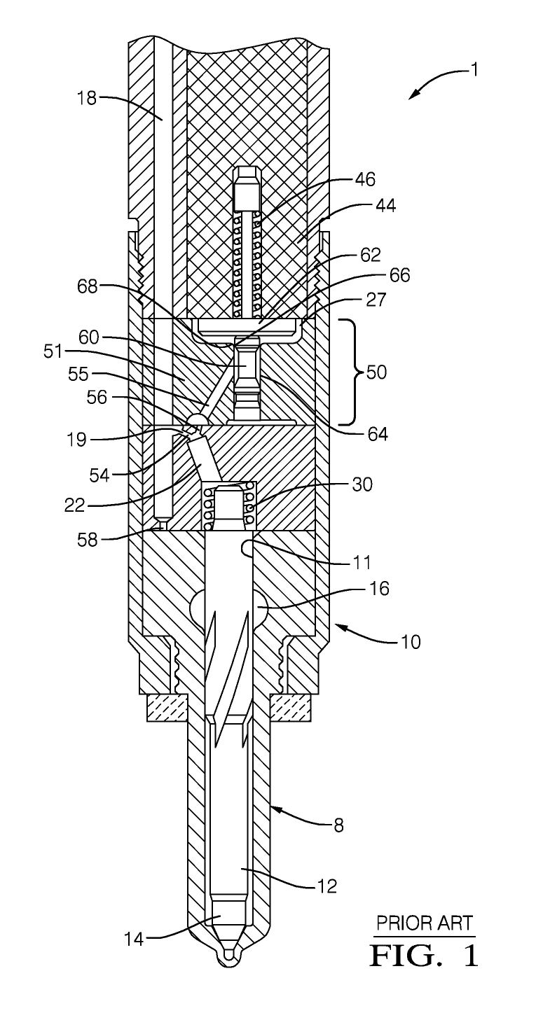

A known fuel injector 1 as illustrated in FIGS. 1 to 4, comprises an injector body 10 including a first region of relatively narrow diameter (the nozzle body 8) and a second, enlarged region. A bore 11 extends through the nozzle body 8 and the second region of the injector 1. An elongate injector needle 12 is slidable within the bore 11, the injector needle 12 including a tip region 14 which is arranged to engage a needle seat defined by an inner surface of the nozzle body 8 adjacent a distal end of the bore 11. The nozzle body 8 is provided with one or more nozzle holes (not shown) communicating with the bore 11, the nozzle holes being positioned such that engagement of the needle tip 14 with the needle seat prevents fluid escaping from the injector body 10 through the apertures, and when the needle tip 14 is lifted from the needle seat, fuel may be delivered through the nozzle holes.

As shown in FIG. 1, the injector needle 12 is shaped such that the region thereof which extends within the injector nozzle body 8 is of smaller diameter than the bore 11 to permit fuel to flow between the injector needle 12 and the inner surface of the nozzle body 8. Within the second region of the injector body 10, the injector needle 12 is of a relatively larger diameter, thereby substantially preventing fluid flowing between the injector needle 12 and the injector body 10, except for a fluted region, which allows fuel to flow from an annular gallery 16 provided in the second region to the nozzle body 8.

The annular gallery 16 communicates with a fuel supply line 18 via an NPO 58 (nozzle path orifice, also referred to as an injection supply orifice), the fuel supply line being arranged to receive high pressure fuel from an accumulator of an associated fuel delivery system (not shown).

A nozzle control chamber/spring chamber 22 is provided within the second region of the injector body 10 at a position remote from the tip region of 14 of the needle 12. The fuel supply line 18 also provides fuel to the nozzle control chamber 22, via an INO 54 (inlet orifice, also referred to as a chamber filling orifice). The INO 54 meets the fuel supply line 18 at an entry 19. A main flow of fuel enters the injector 1 along the fuel supply line 18, and at the entry 19 to the INO 54, the main flow is split into two, such that part of the flow enters the INO 54 and the remainder of the main flow continues along the fuel supply line 18 to the NPO 58.

A compression spring 30 is provided in the nozzle control chamber 22 for biasing the needle 12 towards the needle seat.

The injector in FIG. 1 further comprises an electromagnetic actuator arrangement 44 located above a control valve arrangement 50 comprising a valve body 51.

The control valve arrangement 50 comprises a control valve member 60 carrying an armature 62 at one end of the control valve member 60. The control valve member 60 is slidable within a bore 64 of the control valve arrangement 50. At the armature end of the valve member 60 is provided a sealing face 66 which is engageable with a seat 68 at an end of the bore 64. When the sealing face 66 is brought into contact with the seat 68 a contact a pressure seal is formed. A valve spring 46 is located above the armature 62 provides a closing force for the control valve, acting to urge the sealing face 66 into engagement with its seat 68 and maintain a contact pressure on the valve seat 68 when the valve arrangement 50 is closed.

The control valve arrangement 50 may further comprise a sleeve 80 surrounding the control valve member 60, as illustrated in FIGS. 3 and 4.

The control valve arrangement 50 is also in fluid communication with the fuel supply line 18 via the INO 54, an SPO 56 (spill orifice, also referred to as a control chamber discharge orifice), and an SPO channel 55.

When the control valve arrangement 50 is closed and the sealing face 66 is engaged with the seat 68, there is no fluid communication between the nozzle control chamber 22 and a low pressure fuel return line 27. The nozzle control chamber 22 is subjected to the pressure of fuel within the common rail (not shown). This high pressure fuel exerts a force on the top of the needle 12 which, in combination with pressure from the spring 30, biases the needle into a seated position, such that there is no injection through the nozzle holes.

Energising of the actuator 44 causes the armature 62 to lift such that the valve arrangement 50 opens, i.e. the sealing face 66 lifts from the seat 68. Fuel contained within the nozzle control chamber 22 now has a flow path through the SPO 56 and the SPO channel 55, through typically two communication holes (not shown) into a control valve control chamber 53, past the control valve seat 68 and to the low pressure fuel return line 27. Consequently, fuel flows from the nozzle control chamber 22 to the low pressure fuel return line 27, resulting in a reduction in the fuel pressure in the nozzle control chamber 22. The fuel pressure in the nozzle body 8 is subsequently higher than the fuel pressure in the nozzle control chamber 22 and a pressure force applied to the injector needle 12 overcomes the bias of the spring 30. The injector needle 12 lifts from its seated position and opens the nozzle holes allowing fuel flowing into the nozzle body 8 via the NPO 58 to be injected into a combustion chamber (not shown).

To stop injection, the electromagnetic actuator 44 is de-energised and the valve spring closes the control valve arrangement 50. High pressure fuel from the supply line 18 through the INO 54 and into the nozzle control chamber 22 causes the pressure in the nozzle control chamber 22 to increase until the needle 12 is urged towards the seated position again, thereby causing injection through the nozzle holes to cease.

The embodiments of injector of the present invention are characterised from the above prior art embodiments by provision of a filter which filters flow entering the control chamber 53 of the control valve assembly 50. The filter can be located at various positions between the entry to the INO or SPO from the fuel supply line, and the control valve, to provide the necessary filtration of the flow of fuel entering the control valve.

Group 1

In the first group of the present invention, a particulate filter is located on, or formed by, the control valve sleeve.

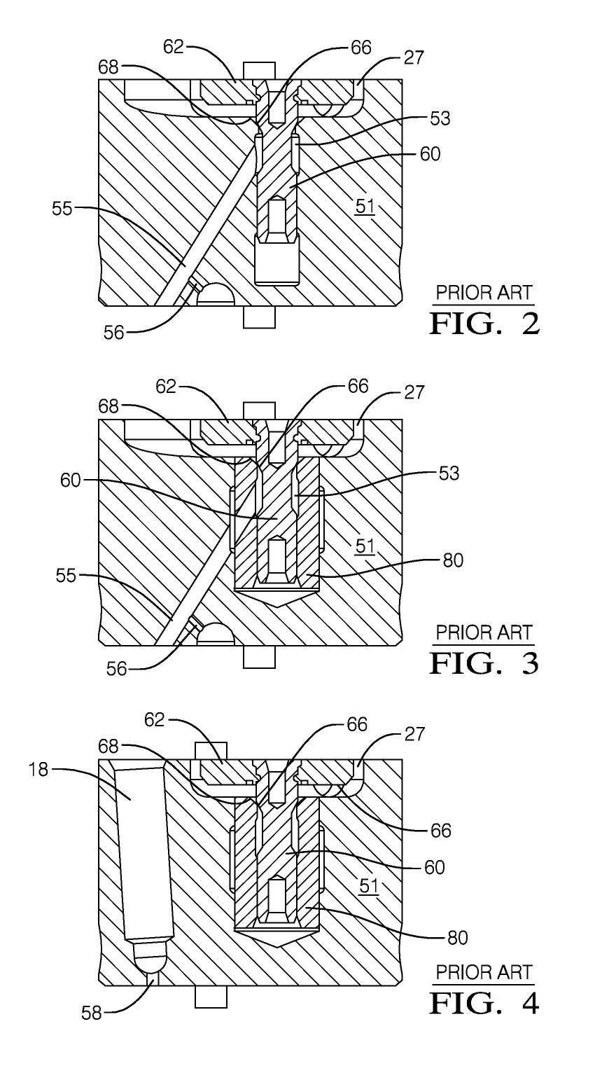

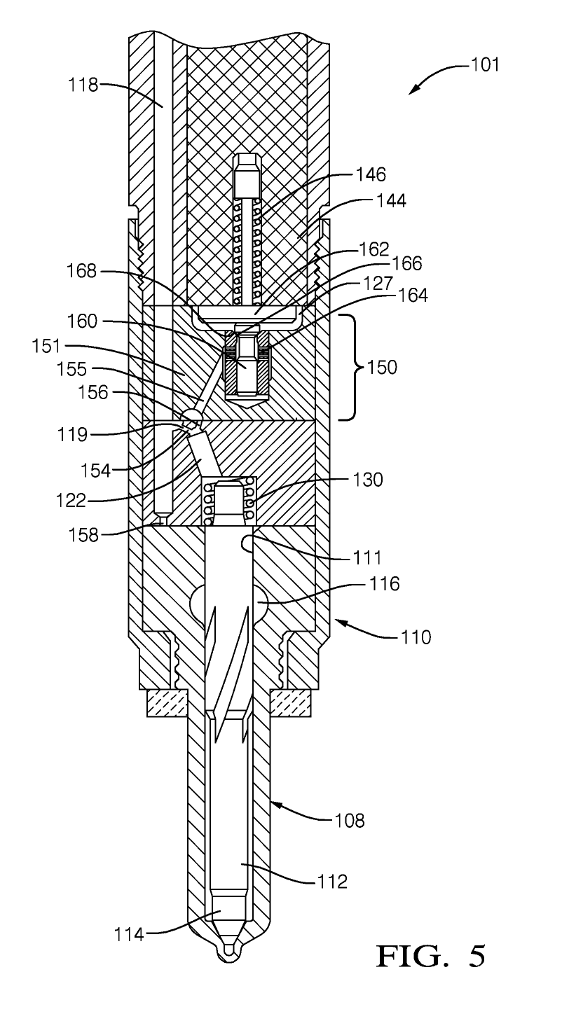

Referring to FIG. 5, in common with the prior art injector, the injector 101 of the present invention comprises an injector body 110 including a nozzle body 108, a fuel supply line 118 into which a main supply of fuel enters the injector 101 and separates at an entry 119 to an INO 154, and within a bore 111, a needle 112 which is biased into a seated position by a compression spring 130. Other components of, and operation of the injector are identical to those of the prior art embodiment of FIGS. 2 and 3.

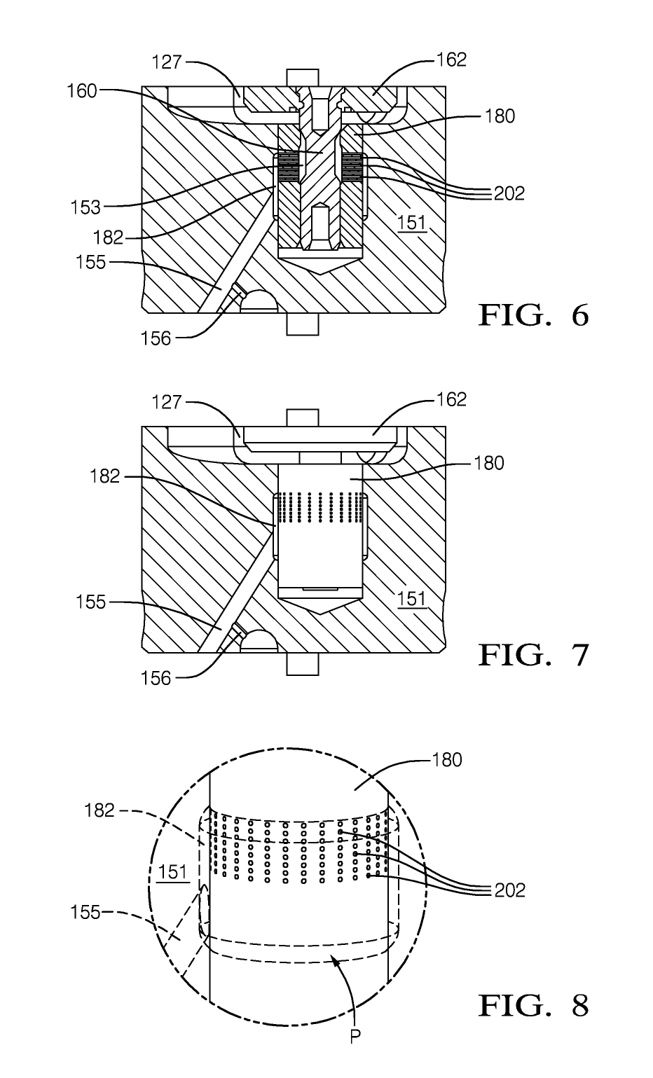

The first embodiment of Group 1 of the present invention further comprises a filter provided on the sleeve 180. The SPO channel 155 is in fluid communication with the sleeve 180 via an annular chamber 182. The filter comprises a plurality of filter orifices, which in the embodiment illustrated in FIGS. 5 to 8 are formed by micro-drilled holes 202. When the control valve arrangement 150 is open, i.e. when the actuator arrangement 144 acts on the valve spring 146, causing the armature 162 to lift thereby lifting the sealing surface 166 thereof away from the control valve seat 168, a fuel path is opened along the SPO 156, SPO channel 155, and the low pressure fuel return 127 via the control valve arrangement 150. Fuel flowing from the SPO channel 155 into the annular chamber 182 must subsequently pass through the filter orifices before reaching the control valve seat 168. Therefore, any fuel contaminant particles which are too large to pass though the filter orifices are trapped upstream of the control valve seat 168, i.e. such particles do not reach the control valve seat 168 and thereby damage to the control valve seat 168 by these particles is prevented.

The micro-drilled holes 202 may each have a radial axis which is coincident with a radial axis of the sleeve 180. Alternatively, the micro-drilled holes 202 may have an axis which is offset relative to a radial axis of the sleeve 180, thereby generating a swirl/rotating flow of fuel passing through the holes into the valve control chamber 153.

The number of filter orifices 202 is selected such that the total flow area provided by the filter orifices 202 is greater than the upstream restriction provided by the SPO 156.

The micro-drilled holes 202 are located symmetrically around the sleeve 180 and therefore stress generated is significantly lower than in prior art embodiments comprising two communication holes into the valve control chamber which generate a mechanical stress concentration. The present invention prevents the deformation of the control valve member 160, and thereby further reducing the possibility of leakage at the valve seat 168.

Furthermore, the hydraulic volume of the micro-drillings 202 is less than the hydraulic volume of the two communication holes of prior art embodiments, providing a more suitable embodiment for a multi-injection process.

A retention zone for contaminant particles may be created at the base of the area provided with micro-drilled holes 202. The particle retention zone is indicated generally at ‘P’ in FIG. 8.

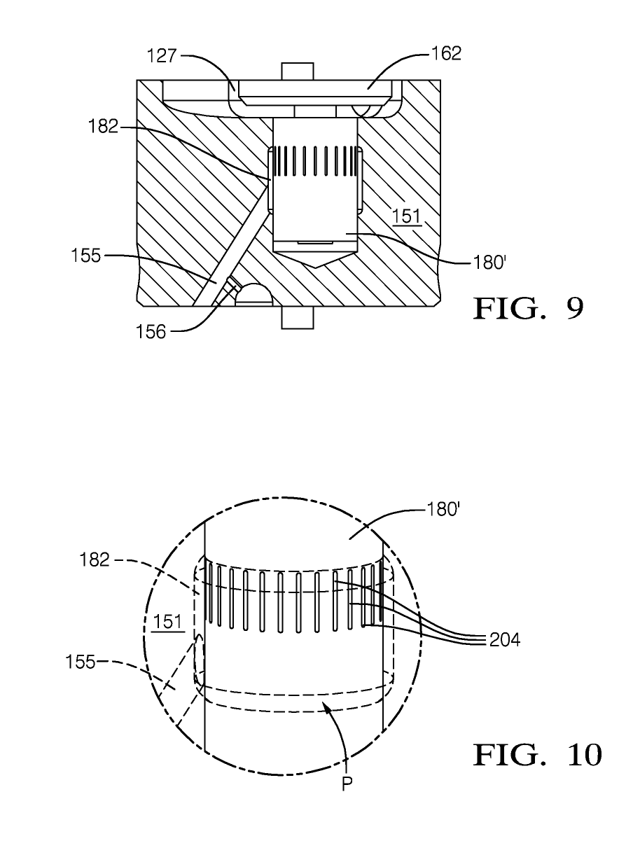

FIGS. 9 and 10 illustrate a second embodiment of Group 1. The second embodiment is similar to the first embodiment and differs only in that the modified sleeve 180′ is provided with a plurality of grooves 204 instead of the holes 202 of the first embodiment. Fuel contaminant particles which are smaller than the width of the grooves 204 cannot pass through the sleeve 180′ and are thereby prevented from reaching the valve seat 168.

In a similar manner to the first embodiment, a particle retention zone is created, as indicated generally by ‘P’ in FIG. 10.

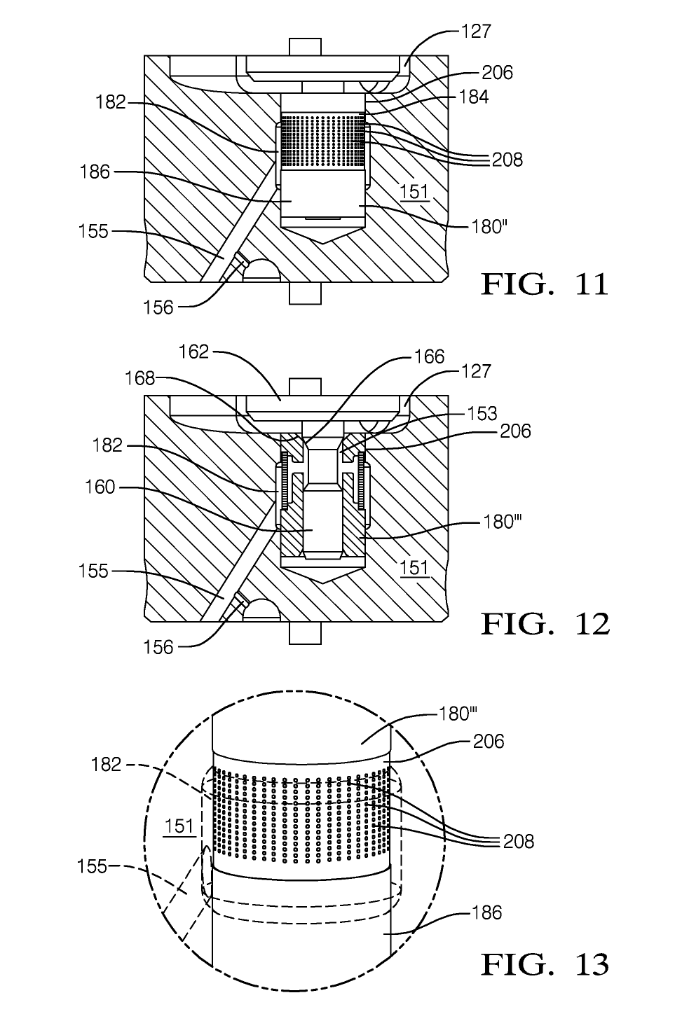

In a third embodiment of Group 1 as illustrated in FIGS. 11 to 13, an annular filter element 206 is integrated into the modified sleeve 180″. The annular filter element 206 is located between a first annular sleeve part 184 and a second annular sleeve part 186, and comprises a plurality of filter orifices 208. In further alternative embodiments, either the first sleeve part 184 or the second sleeve part 186 may be omitted; the filter element 206 may be located above or below (in the orientation shown in the figures) the remaining sleeve part 184, 186.

Group 2

The second group of embodiments in accordance with the present invention is generally similar to the first embodiment; like numerals will be referred to below.

In the embodiments of Group 2, a particulate filter is provided in the region of the SPO 156 or INO 154, or in the SPO channel 155. All embodiments of Group 2 could be applied to an injector with or without a sleeve 180.

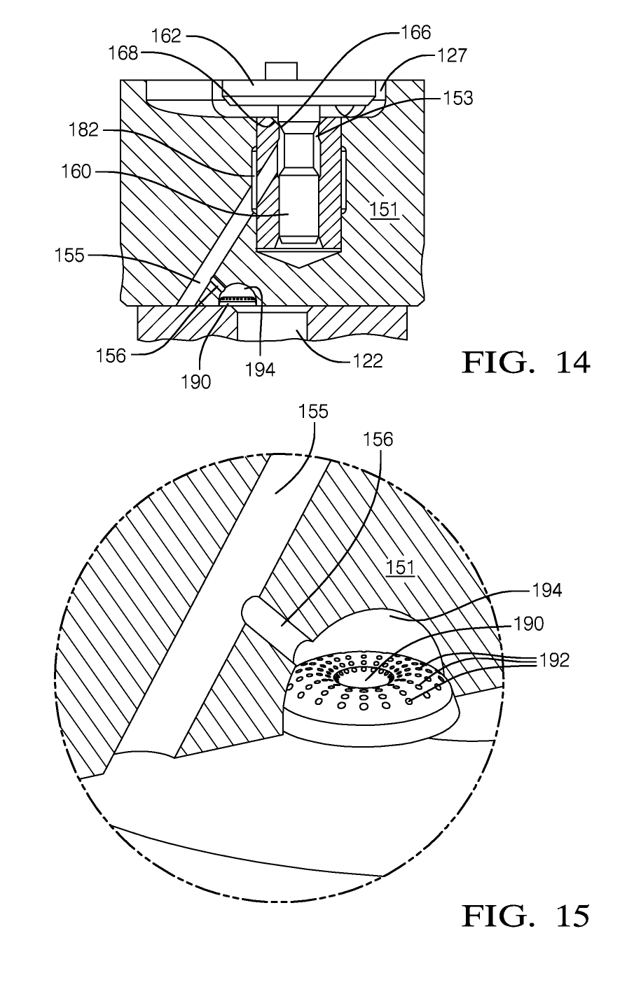

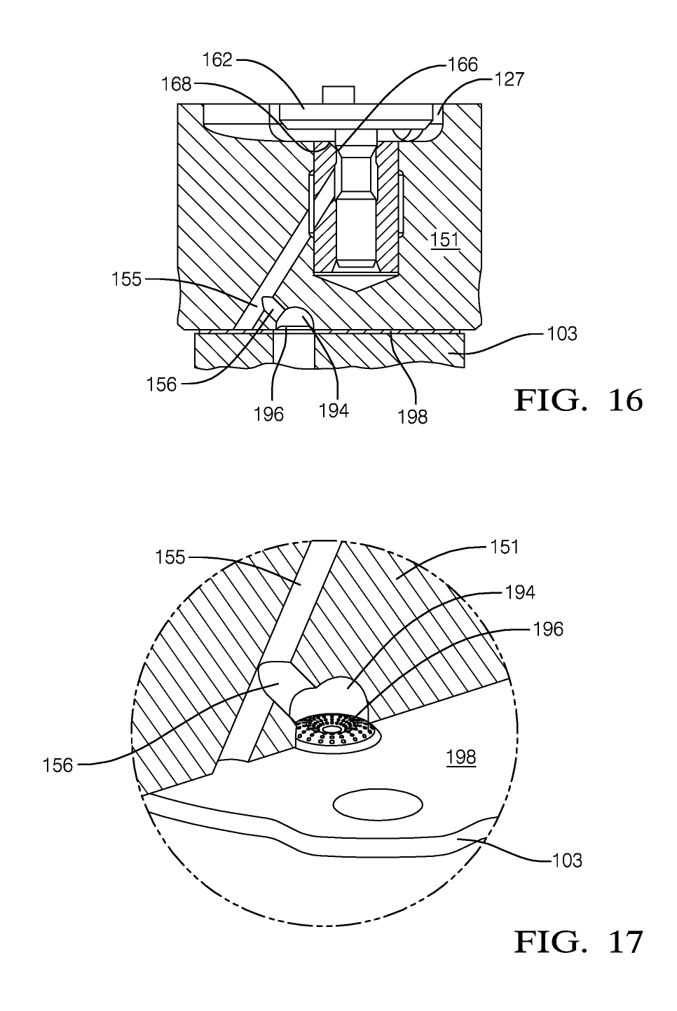

Referring to FIGS. 14 and 15, the first embodiment of Group 2 comprises a filter provided by a filter element 190, located in a chamber 194 provided in the valve body 151 adjacent to the SPO 156. The filter element 190 comprises a plurality of filter orifices 192.

In the embodiment illustrated in FIGS. 14 and 15, the filter element 190 is provided in addition to the SPO 156. However, the number and size of the filter orifices 192 or the filter element 190 could be selected to provide a restriction having the same effect as the original SPO 156, i.e. to provide the same flow area, and therefore the same pressure drop across the filter element 190 as would be provided by the SPO 156. Therefore, the filter element 190 could replace the SPO 156.

The same principle can be applied to the INO 154, i.e. the INO 154 could be replaced by a filter element, provided with a plurality of filter orifices, the number and size of which is selected to provide the same flow area as the standard singular INO 154. Alternatively, a filter could be provided only at, or by, the INO 154, thereby filtering particles arriving at the INO 154 before the fuel flow enters the nozzle control chamber 122, i.e. before the fuel flow enters the SPO 156, SPO channel 155 and control valve arrangement 150.

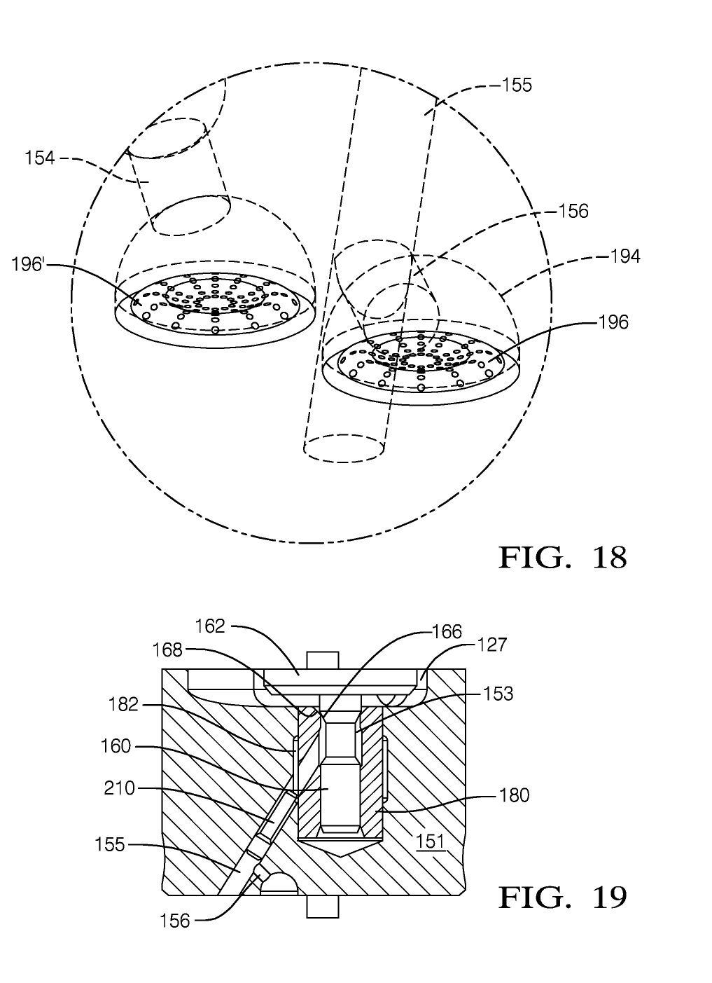

A second embodiment of the Group 2 of the present invention, as illustrated in FIGS. 16 to 18, comprises a filter formed by a filter plate 196 integrated into a separating plate 198, which may be electrically insulating, located between the control valve body 151 and a lower section 103 of the injector containing the nozzle control chamber 122.

In this embodiment, the relative positioning of the filter is simplified in comparison to the first embodiment of Group 2 of the present invention. Furthermore, the integrated filter plate 196 can allow an improved sealing interface between the control valve body 151 and the lower injector section 103 thereby reducing or eliminating leakage between the two sections.

The filter plate 196 can also act as a restriction, thereby allowing removal of the current SPO 156. A similar filter plate could also be used to replace the current INO 154, in addition to, or instead of the filter place 196 provided at/in replacement of the SPO 156. FIG. 16 illustrates a similar plate filter 196′ located at the INO 154 in addition to the filter plate 196 located at the SPO 156.

Similarly, the current NPO 158 could be replaced by a filter plate similar to the filter plate 196.

Referring to FIG. 19, in a third embodiment of Group 2 of the present invention, a filter is formed by a filter tube 210 located in the SPO channel. Therefore, contaminant particles in the fuel flowing through the SPO channel 155 which are larger than the filter holes of the filter tube 210 are prevented from passing through the filter tube 210 and into the control valve arrangement 150.

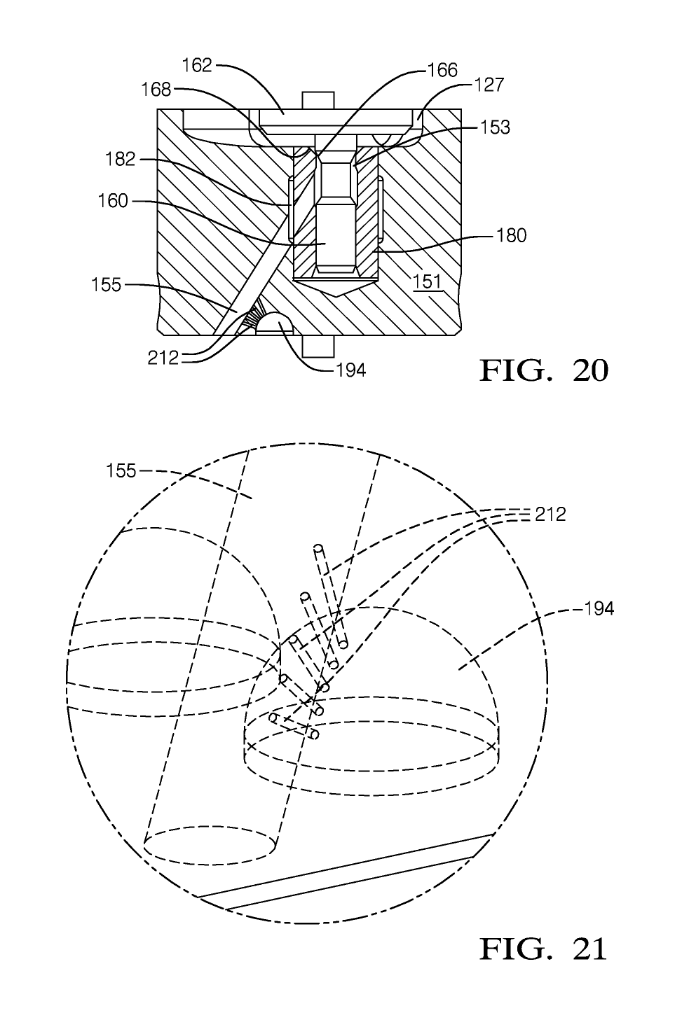

FIGS. 20 and 21, a filter is provided by a plurality of micro-drilled channels 212 between the chamber 194 in the control valve body 151 and the SPO channel 155. In this embodiment, the micro-drilled channels 212 replace the SPO 156; the number and diameter of micro-drilled channels 212 is selected to provide the same restriction as the original SPO 156. This embodiment allows calibration of the SPO 156, in addition to allowing regulation of the size of contaminant particles arriving at the control valve seat 168 through control of the diameter of the micro-drilled channels 212.

It will be appreciated that various changes and modifications can be made to the injector and control valve assembly described herein without departing from the scope of the present invention.

### REFERENCES

### Prior Art

fuel injector 1
injector nozzle 8
injector body 10
bore 11
injector needle 12
tip region 14
annular gallery 16
fuel supply line 18
entry (from fuel supply line to INO) 19
nozzle control chamber 22
low pressure fuel return line 27
compression spring 30
electromagnetic actuator arrangement 44
valve spring 46
control valve arrangement 50
control valve body 51
valve control chamber 53
INO 54
SPO channel 55
SPO 56
NPO 58
control valve member 60
armature 62
bore 64
valve member sealing face 66
seat 68
control valve sleeve 80
Invention
fuel injector 101
injector lower section 103
injector/valve body 110
injector nozzle 108
injector body/nozzle holder body 110
bore 111
injector needle 112
tip region 114
annular gallery 116
fuel supply line 118
entry (from fuel supply line to INO) 119
control chamber 122
low pressure fuel return line 127
compression spring 130
electromagnetic actuator arrangement 144
valve spring 146
control valve arrangement 150
control valve body 151
control valve control chamber 153
spacer component 152
INO 154
SPO channel 155
SPO 156
NPO 158
control valve member 160
armature 162
bore 164
valve member sealing face 166
seat 168
control valve sleeve 180, 180′, 180″
annular chamber 182
first annular sleeve part 184
second annular sleeve part 186
filter element (in control valve body chamber) 190
filter orifices (of filter element) 192
chamber (in valve body) 194
filter plate 196, 196′
separating plate 198
micro-drilled holes 202
slots 204
filter element (of sleeve) 206
filter orifices (of filter element) 208
filter tube 210
micro-drilled channels 212
particle retention zone P

1. (canceled)

2. A fuel injector as claimed in claim 22 wherein the filter is provided by a plurality of filter orifices provided on a sleeve surrounding the control valve.

3. A fuel injector as claimed in claim 2 wherein the filter orifices comprise slots.

4. A fuel injector as claimed in claim 2 wherein the filter orifices comprise micro-drilled holes.

5. A fuel injector as claimed in claim 4 wherein the micro-drilled holes each have a radial axis coincident with a radial axis of the sleeve.

6. A fuel injector as claimed in claim 4 wherein the micro-drilled holes each have a radial axis which is not coincident with a radial axis of the sleeve.

7. A fuel injector as claimed in claim 2 wherein the filter orifices are arranged symmetrically around the sleeve.

8. A fuel injector as claimed in claim 2 wherein the sleeve comprises an annular filter element on which the filter orifices are provided, wherein the filter element is attached to at least one further sleeve element.

9. A fuel injector as claimed in claim 22 wherein the filter is located between an entry to the inlet orifice from the fuel supply line, and the spill orifice channel.

10. A fuel injector as claimed in claim 9 wherein the filter is provided by a filter element comprising a plurality of filter orifices.

11. A fuel injector as claimed in claim 10 wherein the filter element is located between the nozzle control chamber and the spill orifice channel.

12. A fuel injector as claimed in claim 10 wherein the filter element is located between the entry to the inlet orifice from the fuel supply line, and the nozzle control chamber.

13. A fuel injector as claimed in claim 9 wherein the filter is provided by a filter plate comprising a plurality of filter orifices.

14. A fuel injector as claimed in claim 9 wherein the filter plate is integral with an electrically insulating separating plate which separates the control valve body and a further section of the injector containing the nozzle control chamber.

15. A fuel injector as claimed in claim 13 wherein the filter plate is located between the nozzle control chamber and the spill orifice channel.

16. A fuel injector as claimed in claim 13 wherein the filter plate is located between the entry to the inlet orifice from the fuel supply line, and the nozzle control chamber.

17. A fuel injector as claimed in claim 13 further comprising a nozzle path orifice through which fuel from the fuel supply line flows into the nozzle control chamber, wherein the nozzle path orifice is formed by a filter plate.

18. A fuel injector as claimed in claim 9 wherein the filter is provided by a plurality of micro-drilled channels located between the nozzle control chamber and the spill orifice channel.

19. A fuel injector as claimed in claim 11, wherein the filter forms a spill orifice.

20. A fuel injector as claimed in claim 12 wherein the filter forms the inlet orifice.

21. A fuel injector as claimed in claim 22 wherein the filter is provided by a filter tube located in the spill orifice channel.

22. A fuel injector for use in delivering fuel in an internal combustion engine, the fuel injector comprising:
a nozzle,
a control valve body,
a control valve in the control valve body,
a fuel supply line,
a needle moveable to control ejection of fuel through at least one nozzle hole, and
a filter,
the fuel supply line supplying fuel to a nozzle control chamber via an inlet orifice and also supplying fuel to the nozzle;
the needle being controlled by variation of pressure of fuel within in the nozzle control chamber;
the pressure of fuel within the nozzle control chamber being controlled by the control valve, the control valve being movable between an open position wherein a fuel path is provided between the nozzle control chamber and a low pressure fuel return line, via a spill orifice channel and the control valve, and a closed position wherein the control valve closes the flow path;
wherein the filter is provided at a position between an entry to the inlet orifice from the fuel supply line, and the control valve, such that fuel passes through the filter before entering the control valve.

23. A fuel injector as claimed in claim 14 wherein the filter plate is located between the nozzle control chamber and the spill orifice channel.

24. A fuel injector as claimed in claim 14 wherein the filter plate is located between the entry to the inlet orifice from the fuel supply line, and the nozzle control chamber.
